(19) United States
(12) Patent Application Publication
(10) Pub. No.: US 2018/0276176 A1
(43) Pub. Date: Sep. 27, 2018

(54) PERIPHERAL COMPONENT INTERCONNECT EXPRESS (PCIE) COMPLIANT THROUGH-HOLE AND PRESS-FIT CONNECTOR

(71) Applicant: Intel Corporation, Santa Clara, CA (US)

(72) Inventors: Timothy Wig, Northborough, MA (US); Umair I. Khan, Marlborough, MA (US)

(73) Assignee: Intel Corporation, Santa Clara, CA (US)

(21) Appl. No.: 15/641,186

(22) Filed: Jul. 3, 2017

Related U.S. Application Data
(60) Provisional application No. 62/475,732, filed on Mar. 23, 2017.

(51) Int. Cl. G06F 13/42; G06F 13/40

(52) U.S. Cl. CPC G06F 13/4282; G06F 2213/0026; G06F 13/4068

(57) ABSTRACT

Embodiments are directed to systems and device that include a printed circuit board (PCB) and a through-hole pin-field. The pin-field includes a plurality of ground through-holes arranged along a centerline; a plurality of ground pins, each of the plurality of ground pins coupled to a corresponding ground through-hole; a first signal though-hole arranged on a first side of the centerline; a second signal through-hole arrange on a second side of the centerline, the first side oppose the second side; a first signal pin electrically connected to the PCB through the first signal through-hole, the first signal pin comprising a bend in a first direction and disposed proximate the first through-hole; and a second signal pin electrically connected to the PCB through the second signal through-hole, the second signal pin comprising a bend in a second direction opposite the first direction and disposed proximate the second through-hole.

### CROSS REFERENCE TO RELATED APPLICATION

This application claims the benefit pursuant to 35 U.S.C. § 119(e) to U.S. Provisional Patent Applications having U.S. Ser. No. 62/475,732, filed Mar. 23, 2017, the entirety of which are incorporated by reference herein

### TECHNICAL FIELD

Various embodiments generally may relate to the field of computing, and more particularly, to a peripheral component interconnect express (PCIe) compliant through-hole and press-fit connector.

### BACKGROUND

A card edge connector is a socket that accepts a portion of a printed circuit board (PCB) that includes traces leading to the edge of the board. Edge connectors are commonly used in computers for expansion slots for peripheral cards, such as in PCIe compliant devices and communications links.

### BRIEF DESCRIPTION OF THE DRAWINGS

FIG. 1 illustrates an embodiment of a block diagram for a computing system including a multicore processor.

FIG. 2A is a schematic diagram of a connection in accordance with embodiments of the present disclosure.

FIG. 2B is a schematic diagram of a connection illustrating bent signal pins and straighter ground pins in accordance with embodiments of the present disclosure.

FIG. 3 is a schematic diagram of an example through-hole pin-field in accordance with embodiments of the present disclosure.

FIG. 4 is a graphical illustration of far-end cross talk for a system that includes an embodiment of the through-hole pin-field in accordance with embodiments of the present disclosure.

FIG. 5 is a graphical illustration of insertion loss for a system that includes an embodiment of the through-hole pin-field in accordance with embodiments of the present disclosure.

FIG. 6 is a schematic diagram of another example through-hole pin-field in accordance with embodiments of the present disclosure.

FIG. 7 is a schematic diagram of an example through-hole pin-field in accordance with embodiments of the present disclosure.

FIG. 8 is a schematic diagram of an example computing device suitable for use with various components described herein.

FIG. 9 illustrates an example computer-readable storage medium having instructions configured to practice all or selected ones of the operations associated with a computer device in accordance with various embodiments.

FIG. 10 illustrates an embodiment of a computing system including an interconnect architecture in accordance with embodiments of the present disclosure.

FIG. 11 illustrates an embodiment of a interconnect architecture including a layered stack in accordance with embodiments of the present disclosure.

FIG. 12 illustrates an embodiment of a request or packet to be generated or received within an interconnect architecture in accordance with embodiments of the present disclosure.

FIG. 13 illustrates an embodiment of a transmitter and receiver pair for an interconnect architecture in accordance with embodiments of the present disclosure.

FIG. 14 illustrates another embodiment of a block diagram for a computing system including a processor in accordance with embodiments of the present disclosure.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

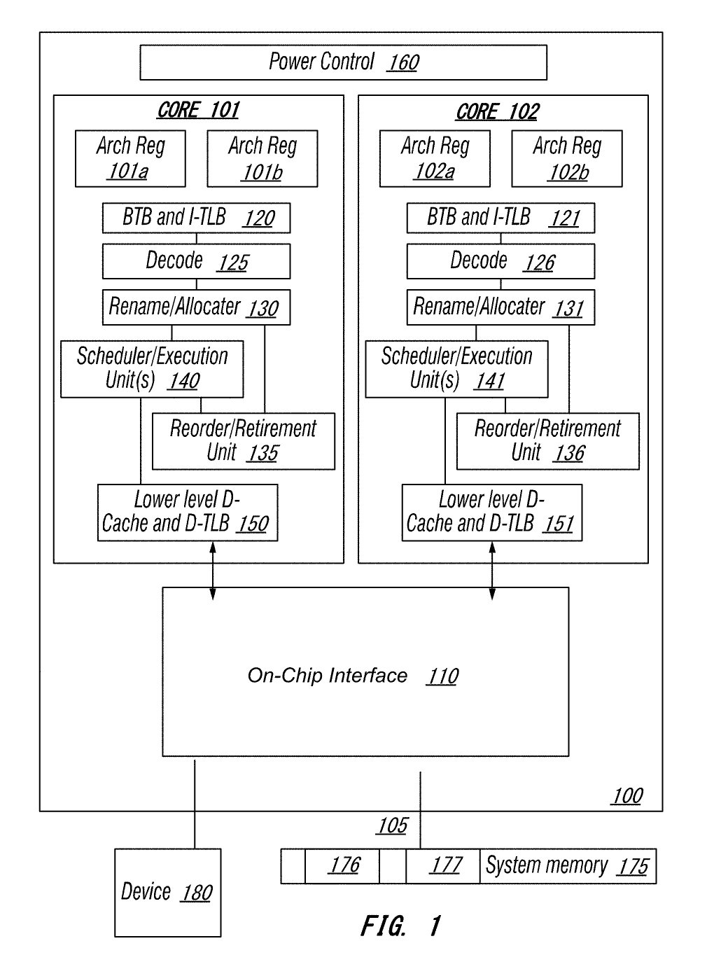

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

Embodiments of the present disclosure are directed to a through-hole connector that facilitates channels to operate at the 32 giga-transfers per second (GT/s) data rates anticipated for Generation 5 (Gen 5) PCIe, while maintaining backward-compatibility with Generations 1-4. PCIe favors through-hole style connectors, as opposed to surface mount connectors, which can increase the cost of the connector component and the corresponding assembly. In addition, typical through-hole connectors may not be compatible with Gen 5 data rates.

Embodiments herein relate to an improved pin-field for the PCI Express connector that enables 32 GT/s non-return-to-zero (NRZ) PCIe Gen 5 data rates for through-hole and press-fit connectors, while preserving mechanical and electrical compatibility with legacy PCIe Gen 1-2-3-4 add-in cards. Generally, embodiments may use straight ground pins in the baseboard pin-field in place of the offset, bent ground pins used in legacy connectors. This approach mitigates a strong bandwidth-limiting resonance that typically falls in the 8 GHz range. This resonance is observed in all PCIe through-hole and press-fit connectors.

The surface mount PCIe connector has historically been regarded as superior to the press-fit and through-hole mount style. In terms of multiple performance metrics, this is generally true for all generations of PCIe. This straight-pin approach has been shown to give performance that is equal to that of surface mount connectors.

Since Through-Hole and Press-Fit connectors share the same baseboard footprint, they will be referred to collectively as Through-Hole, herein.

For Generation 5 (Gen 5) PCIe, we expect that system vendors will again prefer the through-hole solution over surface mount at 32 GT/s speeds. The straight ground pin approach introduced herein, when combined with the enablers developed for Gen 4.0, will enable Gen 5 performance with through-hole connectors, with a modest change to the pin-field.

The conventional through-hole pin-field on a system baseboard is essentially an alternating zig-zag pattern of plated through hole (PTH) vias, with a finished hole size of 0.7 mm (27 mil).

Two different approaches have been previously discussed, namely:

1. A “Dual Inline” approach may have all pins, not just the ground pins, drive directly into the pin-field. While this would likely mitigate the ground resonance phenomena, it would completely block lateral routing through the pin-field, which is required in virtually every baseboard layout. Consequently, routing lengths would increase significantly, requiring the bus to be routed in an indirect “end around” manner to enter the pin-field. Via impedance mismatch issues would likely also become significant, especially at Gen 5 data rates; and

2. A “Dual Stagger” approach may call also for the ground pins to drive directly into the board, but has the pins for signal pair bend away from centerline in a diverging arc. This could provide better impedance control, but, due to the two-axis bend required for the pin geometry, would likely be more difficult to manufacture. This, like the Dual-Inline pin pattern would block lateral routing through the pin-field. This complicates the design and reliability of a press-fit solution, for mechanical reasons.

Several key enablers were developed to mitigate several separate channel impediments to permit Gen 1-2-3 style connectors to operate at 16 GT/s Gen 4.0 data rates. These improvements are now required by the Gen 4.0 PCIe CEM Spec. These have proven insufficient to support speeds substantially beyond 16 GT/s. These previously developed methods can be compatible with the pin-field change described herein, and will be required to achieve 32 GT/s.

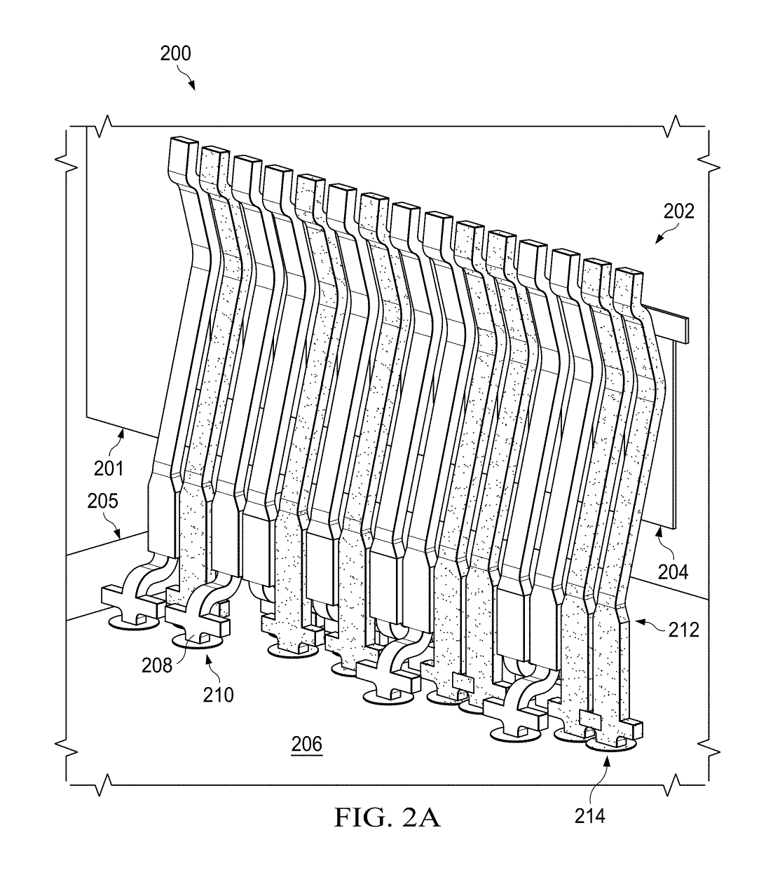

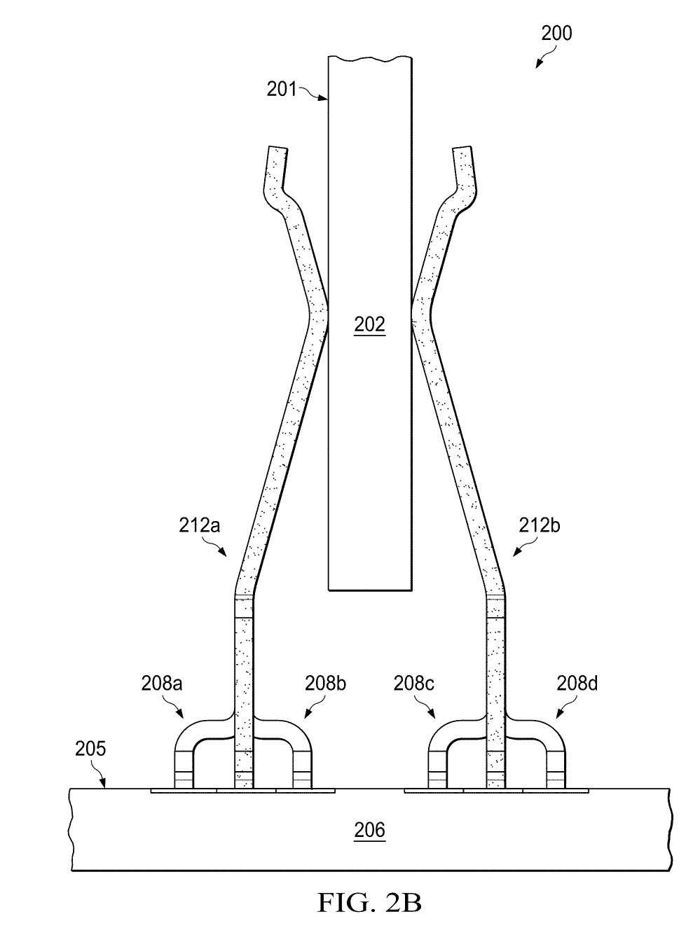

FIG. 2A is a schematic diagram of a connection 200 in accordance with embodiments of the present disclosure. FIG. 2B depicts an example end view of the connector pins engaged with the add-in card 201. The signal pins 208a-d alternate left and right along the centerline of each pin-field set, while the ground pins 212a and 212b enter the board directly.

Connection 200 is between an add-in card 201 and a baseboard 205. The add-in card 201 can include a plurality of metal contact fingers 204 that are electrically connected to circuit components on the add-in card 201 through traces in the printed circuit board (PCB) 202. The baseboard 205 can include a plurality of pins coupled to the baseboard 205 by a corresponding set of through-holes. The pins include “signal” pins that conduct electrical signal representative of signals, such as signal pin 208. Signal pin 208 is coupled to the baseboard 205 PCB 206 by a through hole 210. The set of pins also includes ground pins that carry electrical signals to ground, such as ground pin 212. Ground pin 212 is coupled to a ground plane (e.g., by traces in PCB 206) by a through-hole such as through-hole 214.

Throughout this disclosure, ground pins and through-holes are shown as black in the drawings, while signal pins and through-holes are shown as grey-scale.

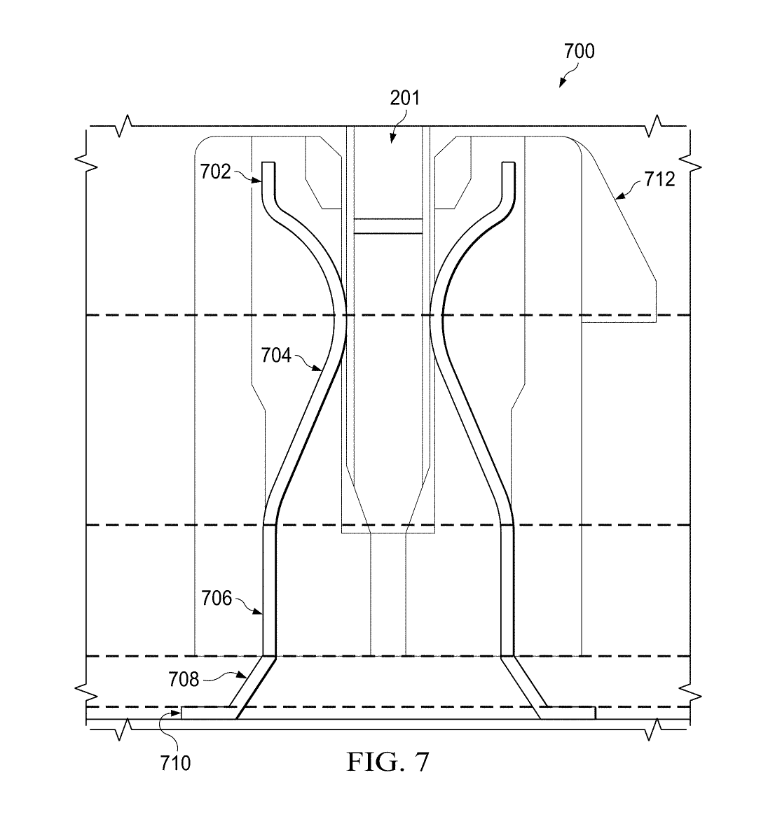

Each pin is electrically isolated from one another by airspace and a plastic PCIe connector shell, which is not shown in FIG. 2A, but is shown as an outline in FIG. 7.

The ground pin 212 does not include a bend proximate the through-hole 214. The signal pin 208, however, does include a bend. That some pins are bent, while others are not, can ease routing through the pin-field. FIG. 2B is a schematic diagram of a connection 200 illustrating bent signal pins and straighter ground pins in accordance with embodiments of the present disclosure. FIG. 2B shows two ground pins 212a and 212b. The portion of each of the ground pins 212a and 212b that are not bent are shown close to the PCB 206. By contrast, FIG. 2B shows four signal pins 208a-d that each include a bend close to the PCB 206. This combination of bent signal pins and semi-straight ground pins permits routing through the pin-field. Routing through the pin-field facilitates shortened routing channels.

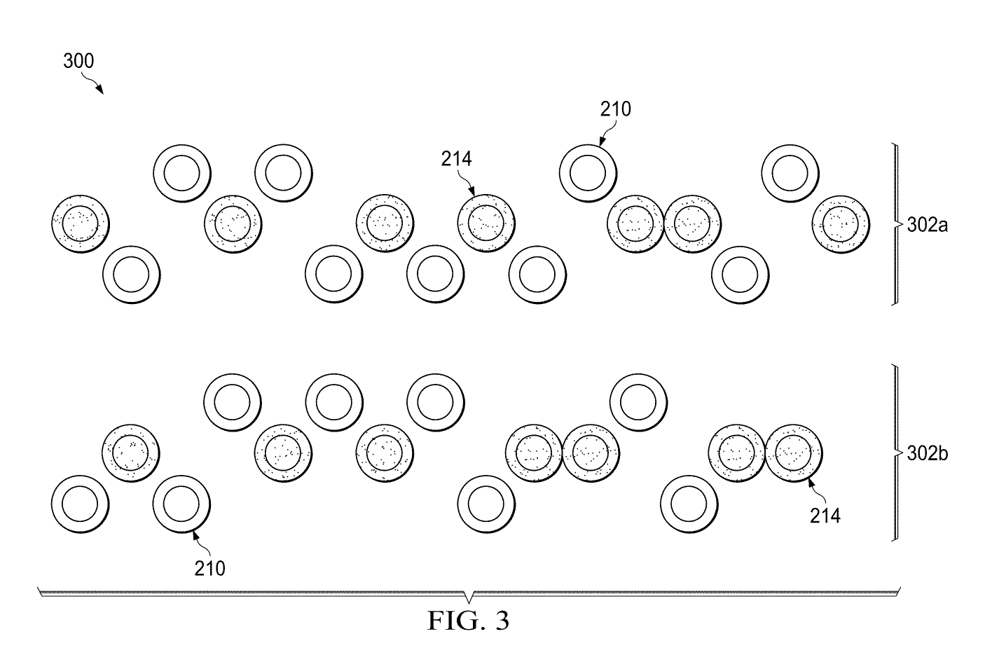

FIG. 3 is a schematic diagram of an example through-hole pin-field 300 in accordance with embodiments of the present disclosure. The through-hole pin-field 300 includes two sets of through-holes: a first set 302a and a second set 302b. Each set of through-holes includes a combination of signal through-holes, such as signal through-hole 210a and 210b, and ground through-holes, such as ground through-holes 214a and 214b. In FIG. 3, the example pin-field 300 includes ground pins have been aligned along a centerline 304a or 304b of each pin-field set 302a and 302b, respectively. The signal through-holes are organized on either side of the centerline 304a or 304b.

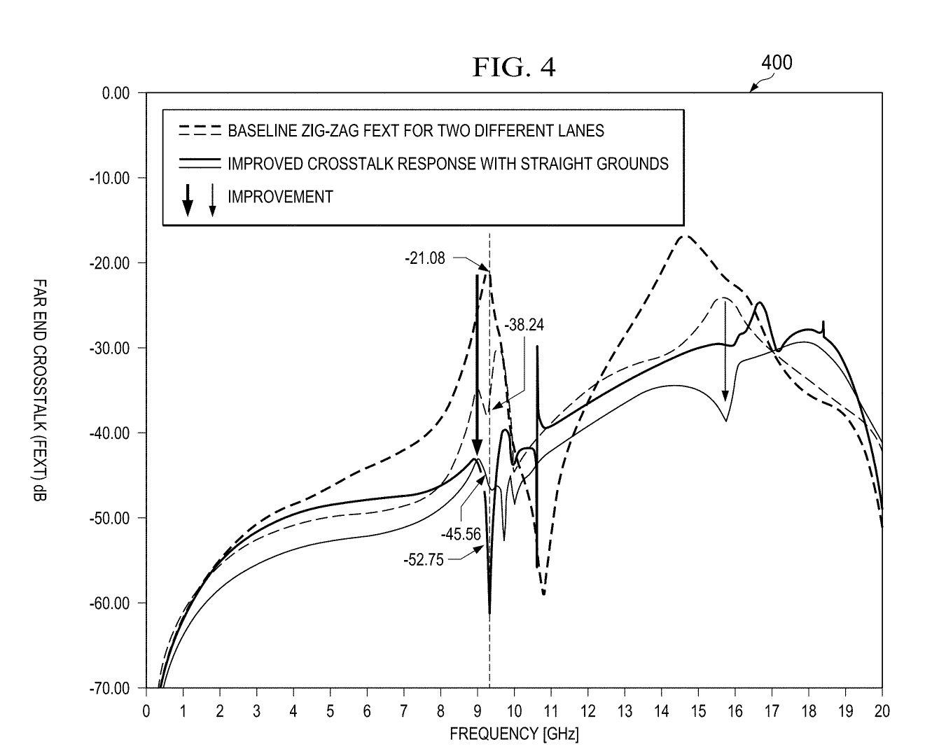

Advantages of various embodiments of this disclosure are readily apparent to those of skill in the art. As an example, a comparison of magnitude of the far-end crosstalk (FEXT) is shown in FIG. 4, for the two strongest aggressor crosstalk paths in the pin-field. FIG. 4 is a graphical illustration of far-end cross talk for a system that includes an embodiment of the through-hole pin-field in accordance with embodiments of the present disclosure. The crosstalk is markedly reduced, by as much as 25 dB or more. Most importantly, the crosstalk is reduced to below −40 dB for much of the 0 to 16 GHz range and below −30 dB for virtually all of that range.

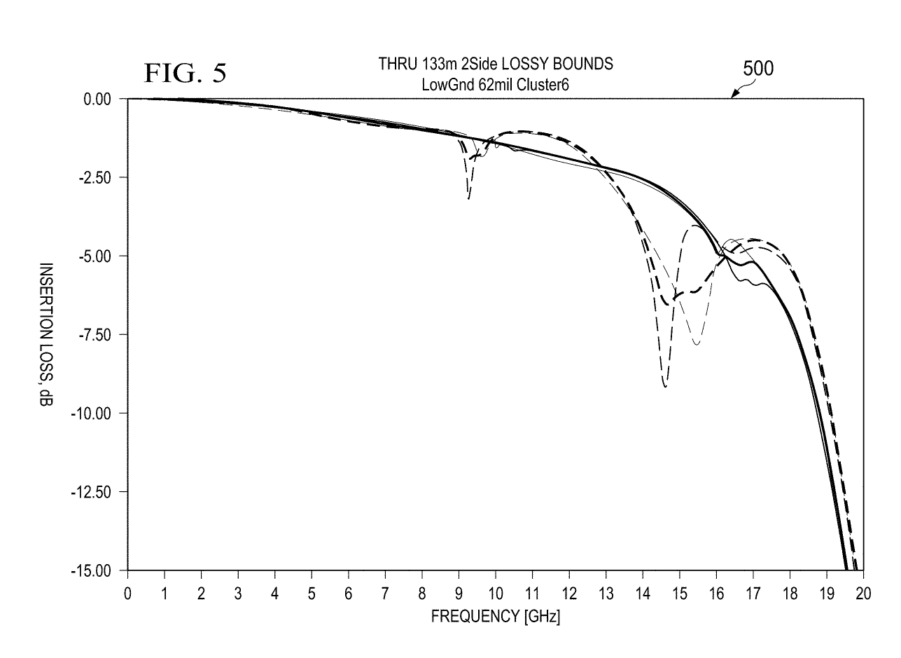

FIG. 5 is a graphical illustration of insertion loss for a system that includes an embodiment of the through-hole pin-field in accordance with embodiments of the present disclosure. Improvement in insertion loss is also observed in the plot shown in FIG. 5, where insertion loss is compared for all three lane configurations. Two prominent insertion loss dropouts are corrected, effectively extending the resonance-free bandwidth beyond 16 GHz. The remaining 0 to 15 GHz frequency roll-off may be largely due to impedance mismatches, while 19 GHz roll-off may be due to a stub resonance in the connector preload section.

An additional advantage of embodiments of the present disclosure is that some embodiments facilitate realignment of the up/down bending pattern for the signal pins. This realignment provides a critical advantage for reducing crosstalk, particularly for the 100 MHz clock pair. The pin-swap that straight grounds now permits reduces a very high clock crosstalk by 10 dB across the entire frequency band, and even more at lower frequencies.

The pin swap also allows us the flexibility of altering the relative phasing of crosstalk among the high speed pairs.

Additionally, the placement of sideband signals may be placed on either the inner or outer row (bent in or bent out) to suit routing and signal integrity.

Because of these opportunities to reorder the up/down pin “bending order”, numerous pin-fields are possible. For the sake of the standard, it is likely that a single pin-field configuration will be selected.

Mixed Ground Placement

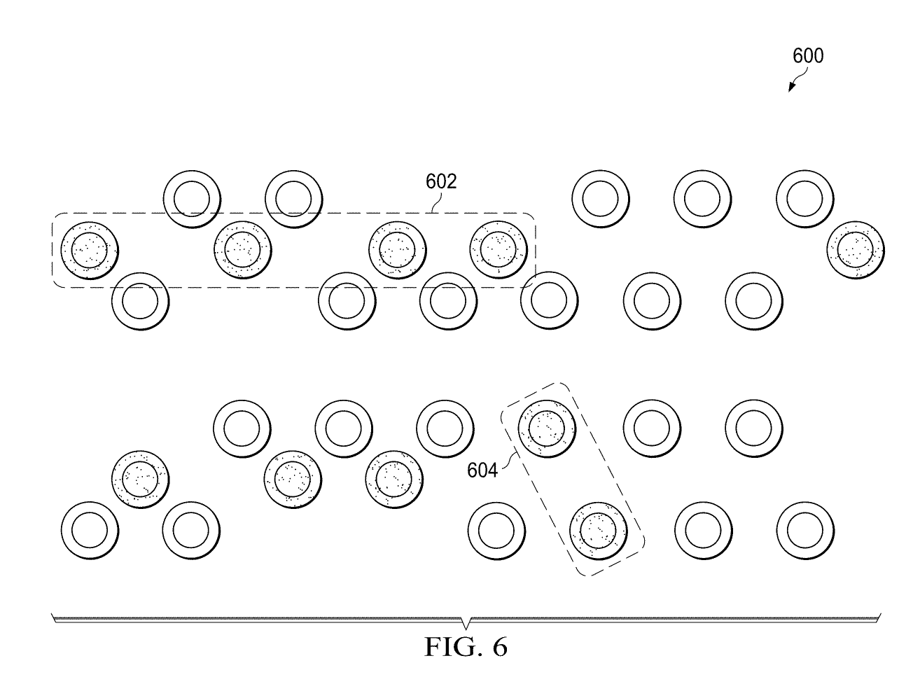

FIG. 6 is a schematic diagram of another example through-hole pin-field in accordance with embodiments of the present disclosure. Embodiments of the present disclosure include a pin-field that includes joined double ground through-holes. The joined double ground through-holes can be combined with the straight ground pins described herein, resulting in an increase in the ease of routing through the pin-field, approaching the flexibility allowed by the legacy Gen 1-2-3-4 style connector pin-field. The mixed pin-field is shown in FIG. 6. In this scheme, “lone” ground pins such as those highlighted by box 602, may be made straight, as explained herein. The “double” ground through-holes are highlighted by box 604. Double ground through-holes include two ground pins immediately adjacent in the pin-field. The ground pins for the joined double ground through-holes are in the “bent” configuration, discussed above for the signal pins (e.g., signal pin 208).

Impedance Optimizations

FIG. 7 is a schematic diagram of a pin optimization 700 in accordance with embodiments of the present disclosure. PCIe connectors were originally optimized for a differential characteristic impedance of approximately 100 Ohms. More recent channel designs, including PCIe Gen3 and Gen 4, typically use mating interconnect (including printed circuit board routing) having a characteristic impedance of 85 ohms. This impedance mismatch will degrade the performance of the link, potentially limiting the maximum data rate, or reducing the possible routing length of the channel.

It may be desirable for the connector to be optimized segment-by-segment to have a more uniform characteristic impedance. In previous generations of PCIe, this was much less important, due to the relatively small size of the connector with respect to a symbol, and the relatively low bandwidth required of the connector. The optimizations can include optimizing the PCB footprint beneath the feet, widening the ankle section 708, narrowing the waist section 706, broadening the beam section 704, and shortening the preload 702.

FIG. 7 illustrates example pin segments, any of which can be optimized. For example, the preload 702 can be optimized. The preload is a portion of the contact length of the pin that is used to hold the springy connector contact against the wall of the connector shell 712.

Another segment of the pin is the beam 704. The beam 704 can be optimized for spring tension and impedance by widening it, for example. The waist 706 can also be optimized, e.g., by narrowing it. The waist 706 is captivated by the plastic connector shell 712. The ankle 708 leads from the pad to the plastic shell. And the solder pads 710, which can be gull-wing connector pads (feet) can be optimized.

The pin(s) can be optimized segment-by-segment for an optimized impedance profile. Segment-by-segment optimization can include broadening, narrowing, or otherwise contouring the connector contact, such as the solder pads/gull wing terminal 710 at the feet, the ankle 708 that leads to the gull wing terminal, the captivated contact length 702, and the free-moving beam 704 that mates with the add-in card edge finger.

Non-PCIe Applications

In the case of similar card edge connectors that are not intended for PCIe, a similar benefit can likely be obtained for mitigating the effects of the ground conductor resonance.

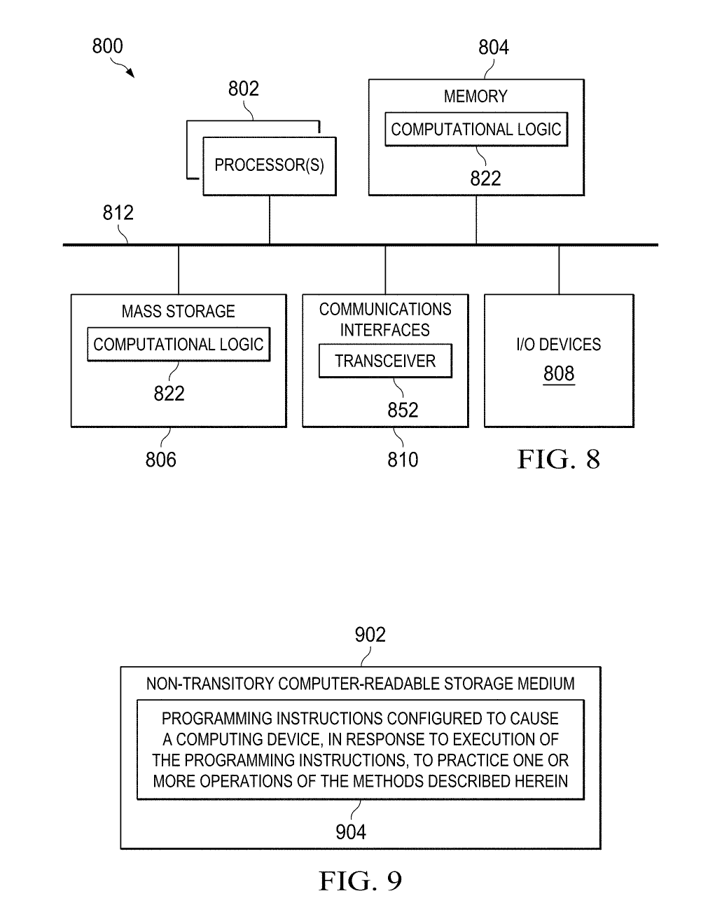

FIG. 8 illustrates a block diagram of an example computing device 800 suitable for use with various components described herein. As shown, computing device 800 may include one or more processors or processor cores 802 and system memory 804. For the purpose of this application, including the claims, the terms “processor” and “processor cores” may be considered synonymous, unless the context clearly requires otherwise. The processor 802 may include any type of processors, such as a central processing unit (CPU), a microprocessor, and the like. The processor 802 may be implemented as an integrated circuit having multi-cores, e.g., a multi-core microprocessor. The computing device 800 may include mass storage devices 806 (such as diskette, hard drive, volatile memory (e.g., dynamic random-access memory (DRAM), compact disc read-only memory (CD-ROM), digital versatile disk (DVD), and so forth). In general, system memory 804 and/or mass storage devices 806 may be temporal and/or persistent storage of any type, including, but not limited to, volatile and non-volatile memory, optical, magnetic, and/or solid state mass storage, and so forth. Volatile memory may include, but is not limited to, static and/or dynamic random access memory. Non-volatile memory may include, but is not limited to, electrically erasable programmable read-only memory, phase change memory, resistive memory, and so forth.

The computing device 800 may further include I/O devices 808 (such as a display (e.g., a touchscreen display), keyboard, cursor control, remote control, gaming controller, image capture device, and so forth) and communication interfaces 810 (such as network interface cards, modems, infrared receivers, radio receivers (e.g., Bluetooth), and so forth).

The communication interfaces 810 may include communication chips (not shown) that may be configured to operate the device 800 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 810 may operate in accordance with other wireless protocols in other embodiments. In various embodiments, the communication interfaces 810 may include a transceiver 852. In some embodiments, the transceiver 852 may be coupled with other components of the computer device 800 and/or may not be included within the communication interfaces 810.

The above-described computing device 800 elements may be coupled to each other via system bus 812, which may represent one or more buses. In the case of multiple buses, they may be bridged by one or more bus bridges (not shown). Each of these elements may perform its conventional functions known in the art. In particular, system memory 804 and mass storage devices 806 may be employed to store a working copy and a permanent copy of the programming instructions for the operation of various components of computing device 800, including but not limited to an operating system of computing device 800 and/or one or more applications. The various elements may be implemented by assembler instructions supported by processor(s) 802 or high-level languages that may be compiled into such instructions.

The permanent copy of the programming instructions may be placed into mass storage devices 806 in the factory, or in the field through, for example, a distribution medium (not shown), such as a compact disc (CD), or through communication interface 810 (from a distribution server (not shown)). That is, one or more distribution media having an implementation of the agent program may be employed to distribute the agent and to program various computing devices.

The number, capability, and/or capacity of the elements 808, 810, 812 may vary, depending on whether computing device 800 is used as a stationary computing device, such as a set-top box or desktop computer, or a mobile computing device, such as a tablet computing device, laptop computer, game console, or smartphone. Their constitutions are otherwise known, and accordingly will not be further described.

In embodiments, memory 804 may include computational logic 822 configured to implement various firmware and/or software services associated with operations of the computing device 800. For some embodiments, at least one of processors 802 may be packaged together with computational logic 822 configured to practice aspects of embodiments described herein to form a System in Package (SiP) or a System on Chip (SoC).

In various implementations, the computing device 800 may comprise one or more components of a data center, a laptop, a netbook, a notebook, an ultrabook, a smartphone, a tablet, a personal digital assistant (PDA), an ultra mobile PC, a mobile phone, or a digital camera. In further implementations, the computing device 800 may be any other electronic device that processes data.

FIG. 9 illustrates example computer-readable storage medium 902 having instructions configured to practice all or selected ones of the operations associated with a in accordance with various embodiments. As illustrated, computer-readable storage medium 902 may include a number of programming instructions 904. The storage medium 902 may represent a broad range of non-transitory persistent storage medium known in the art, including but not limited to flash memory, dynamic random access memory, static random access memory, an optical disk, a magnetic disk, etc. Programming instructions 904 may be configured to enable a device, e.g., computer device 800 in response to execution of the programming instructions 704, to perform, e.g., but not limited to, various operations described herein. In alternate embodiments, programming instructions 704 may be disposed on multiple computer-readable storage media 702. In alternate embodiment, storage medium 702 may be transitory, e.g., signals encoded with programming instructions 704.

Referring back to FIG. 8, for an embodiment, at least one of processors 802 may be packaged together with memory having all or portions of computational logic 822. For an embodiment, at least one of processors 802 may be packaged together with memory having all or portions of computational logic 822 to form a System in Package (SiP). For an embodiment, at least one of processors 802 may be integrated on the same die with memory having all or portions of computational logic 822. For an embodiment, at least one of processors 802 may be packaged together with memory having all or portions of computational logic 822 to form a System on Chip (SoC).

In embodiments, one or more of the elements of FIG. 8, for example I/O devices 808 or some other device(s), may be coupled with a bus, board, or some other coupling via a pin-field as discussed herein.

Machine-readable media (including non-transitory machine-readable media, such as machine-readable storage media), methods, systems and devices for performing the above-described techniques are illustrative examples of embodiments disclosed herein. Additionally, other devices in the above-described interactions may be configured to perform various disclosed techniques.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

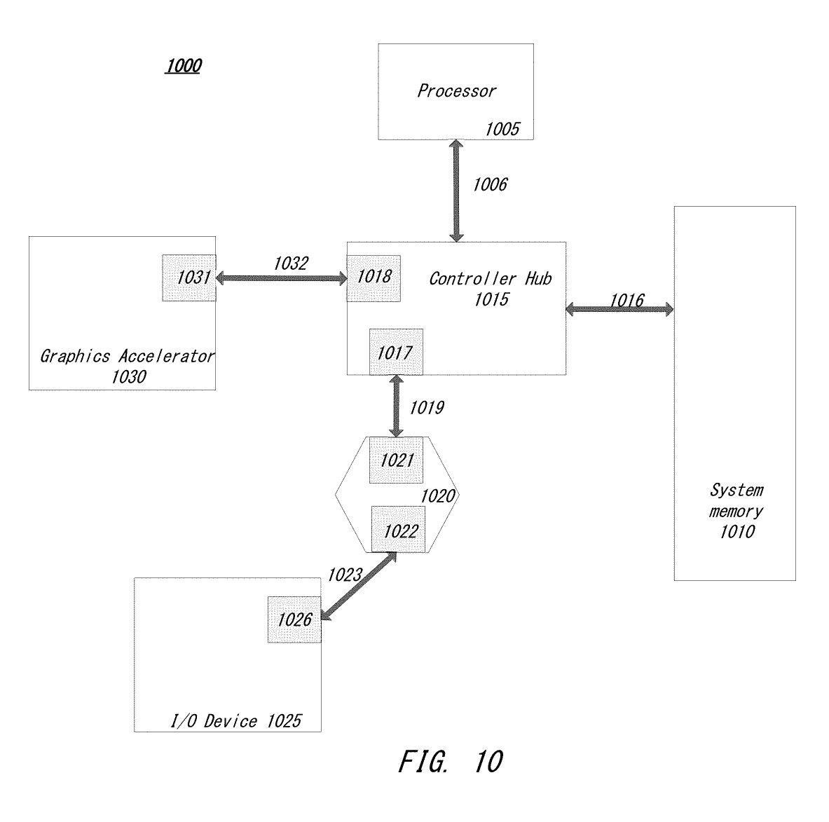

Referring to FIG. 10, an embodiment of a fabric composed of point-to-point Links that interconnect a set of components is illustrated. System 1000 includes processor 1005 and system memory 1010 coupled to controller hub 1015. Processor 1005 includes any processing element, such as a microprocessor, a host processor, an embedded processor, a co-processor, or other processor. Processor 1005 is coupled to controller hub 1015 through front-side bus (FSB) 1006. In one embodiment, FSB 1006 is a serial point-to-point interconnect as described below. In another embodiment, link 1006 includes a serial, differential interconnect architecture that is compliant with different interconnect standard.

System memory 1010 includes any memory device, such as random access memory (RAM), non-volatile (NV) memory, or other memory accessible by devices in system 1000. System memory 1010 is coupled to controller hub 1015 through memory interface 1016. Examples of a memory interface include a double-data rate (DDR) memory interface, a dual-channel DDR memory interface, and a dynamic RAM (DRAM) memory interface.

In one embodiment, controller hub 1015 is a root hub, root complex, or root controller in a Peripheral Component Interconnect Express (PCIe or PCIE) interconnection hierarchy. Examples of controller hub 1015 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 1005, while controller 1015 is to communicate with I/O devices, in a similar manner as described below. In some embodiments, peer-to-peer routing is optionally supported through root complex 1015.

Here, controller hub 1015 is coupled to switch/bridge 1020 through serial link 1019. Input/output modules 1017 and 1021, which may also be referred to as interfaces/ports 1017 and 1021, include/implement a layered protocol stack to provide communication between controller hub 1015 and switch 1020. In one embodiment, multiple devices are capable of being coupled to switch 1020.

Switch/bridge 1020 routes packets/messages from device 1025 upstream, i.e. up a hierarchy towards a root complex, to controller hub 1015 and downstream, i.e. down a hierarchy away from a root controller, from processor 1005 or system memory 1010 to device 1025. Switch 1020, in one embodiment, is referred to as a logical assembly of multiple virtual PCI-to-PCI bridge devices. Device 1025 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 1025 may include a PCIe to PCI/PCI-X bridge to support legacy or other version PCI devices. Endpoint devices in PCIe are often classified as legacy, PCIe, or root complex integrated endpoints.

Graphics accelerator 1030 is also coupled to controller hub 1015 through serial link 1032. In one embodiment, graphics accelerator 1030 is coupled to an MCH, which is coupled to an ICH. Switch 1020, and accordingly I/O device 1025, is then coupled to the ICH. I/O modules 1031 and 1018 are also to implement a layered protocol stack to communicate between graphics accelerator 1030 and controller hub 1015. Similar to the MCH discussion above, a graphics controller or the graphics accelerator 1030 itself may be integrated in processor 1005.

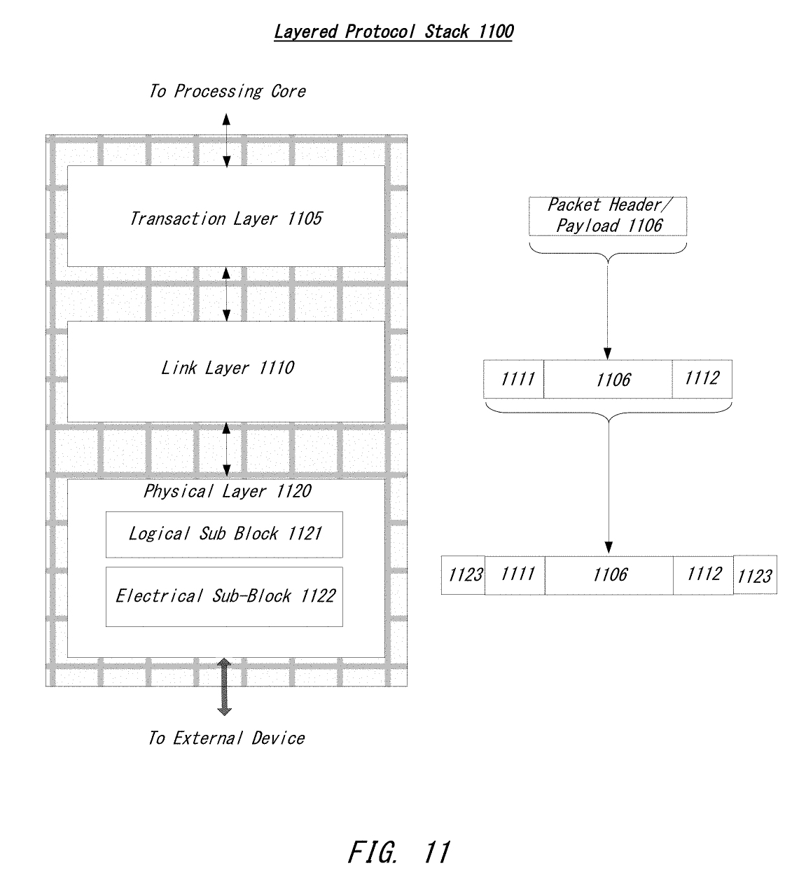

Turning to FIG. 11 an embodiment of a layered protocol stack is illustrated. Layered protocol stack 1100 includes any form of a layered communication stack, such as a Quick Path Interconnect (QPI) stack, a PCIe stack, a next generation high performance computing interconnect stack, or other layered stack. Although the discussion immediately below in reference to FIGS. 10-13 are in relation to a PCIe stack, the same concepts may be applied to other interconnect stacks. In one embodiment, protocol stack 1100 is a PCIe protocol stack including transaction layer 1105, link layer 1110, and physical layer 1120. An interface, such as interfaces 1017, 1018, 1021, 1022, 1026, and 1031 in FIG. 1, may be represented as communication protocol stack 1100. Representation as a communication protocol stack may also be referred to as a module or interface implementing/including a protocol stack.

PCI Express uses packets to communicate information between components. Packets are formed in the Transaction Layer 1105 and Data Link Layer 1110 to carry the information from the transmitting component to the receiving component. As the transmitted packets flow through the other layers, they are extended with additional information necessary to handle packets at those layers. At the receiving side the reverse process occurs and packets get transformed from their Physical Layer 1120 representation to the Data Link Layer 1110 representation and finally (for Transaction Layer Packets) to the form that can be processed by the Transaction Layer 1105 of the receiving device.

Transaction Layer

In one embodiment, transaction layer 1105 is to provide an interface between a device's processing core and the interconnect architecture, such as data link layer 1110 and physical layer 1120. In this regard, a primary responsibility of the transaction layer 1105 is the assembly and disassembly of packets (i.e., transaction layer packets, or TLPs). The translation layer 1105 typically manages credit-base flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 1105. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message space transactions (or, simply messages) are defined to support in-band communication between PCIe agents.

Therefore, in one embodiment, transaction layer 1105 assembles packet header/payload 1106. Format for current packet headers/payloads may be found in the PCIe specification at the PCIe specification website.

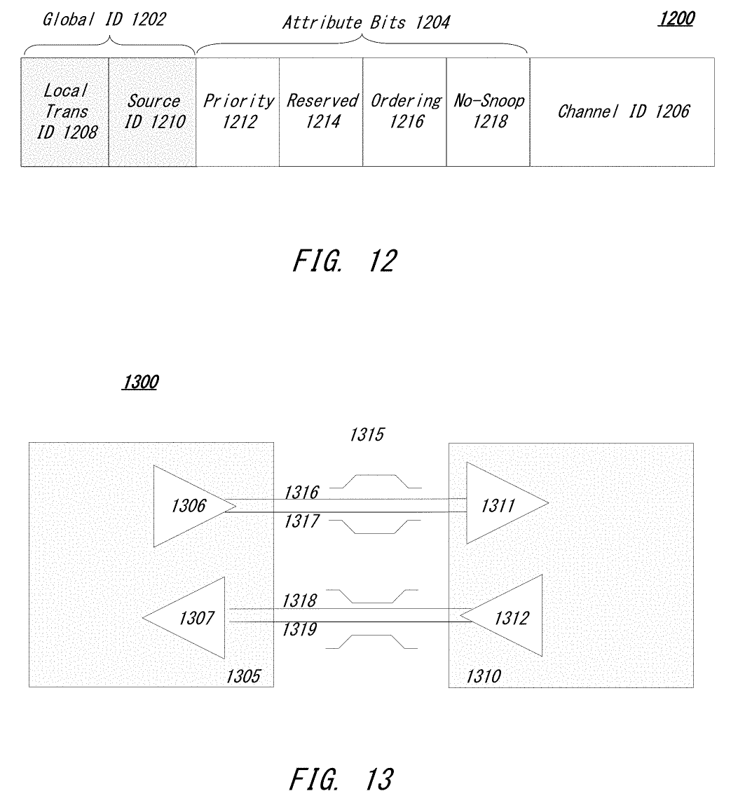

Quickly referring to FIG. 12, an embodiment of a PCIe transaction descriptor is illustrated. In one embodiment, transaction descriptor 1200 is a mechanism for carrying transaction information. In this regard, transaction descriptor 1200 supports identification of transactions in a system. Other potential uses include tracking modifications of default transaction ordering and association of transaction with channels.

Transaction descriptor 1200 includes global identifier field 1202, attributes field 1204 and channel identifier field 1206. In the illustrated example, global identifier field 1202 is depicted comprising local transaction identifier field 1208 and source identifier field 1210. In one embodiment, global transaction identifier 1202 is unique for all outstanding requests.

According to one implementation, local transaction identifier field 1208 is a field generated by a requesting agent, and it is unique for all outstanding requests that require a completion for that requesting agent. Furthermore, in this example, source identifier 1210 uniquely identifies the requestor agent within a PCIe hierarchy. Accordingly, together with source ID 1210, local transaction identifier 1208 field provides global identification of a transaction within a hierarchy domain.

Attributes field 1204 specifies characteristics and relationships of the transaction. In this regard, attributes field 1204 is potentially used to provide additional information that allows modification of the default handling of transactions. In one embodiment, attributes field 1204 includes priority field 1212, reserved field 1214, ordering field 1216, and no-snoop field 1218. Here, priority sub-field 1212 may be modified by an initiator to assign a priority to the transaction. Reserved attribute field 1214 is left reserved for future, or vendor-defined usage. Possible usage models using priority or security attributes may be implemented using the reserved attribute field.

In this example, ordering attribute field 1216 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 1218 is utilized to determine if transactions are snooped. As shown, channel ID Field 1206 identifies a channel that a transaction is associated with.

Link Layer

Link layer 1110, also referred to as data link layer 1110, acts as an intermediate stage between transaction layer 1105 and the physical layer 1120. In one embodiment, a responsibility of the data link layer 1110 is providing a reliable mechanism for exchanging Transaction Layer Packets (TLPs) between two components a link. One side of the Data Link Layer 1110 accepts TLPs assembled by the Transaction Layer 1105, applies packet sequence identifier 1111, i.e. an identification number or packet number, calculates and applies an error detection code, i.e. CRC 1112, and submits the modified TLPs to the Physical Layer 1120 for transmission across a physical to an external device.

Physical Layer

In one embodiment, physical layer 1120 includes logical sub block 1121 and electrical sub-block 1122 to physically transmit a packet to an external device. Here, logical sub-block 1121 is responsible for the “digital” functions of Physical Layer 1121. In this regard, the logical sub-block includes a transmit section to prepare outgoing information for transmission by physical sub-block 1122, and a receiver section to identify and prepare received information before passing it to the Link Layer 1110.

Physical block 1122 includes a transmitter and a receiver. The transmitter is supplied by logical sub-block 1121 with symbols, which the transmitter serializes and transmits onto to an external device. The receiver is supplied with serialized symbols from an external device and transforms the received signals into a bit-stream. The bit-stream is de-serialized and supplied to logical sub-block 1121. In one embodiment, an 8 b/10 b transmission code is employed, where ten-bit symbols are transmitted/received. Here, special symbols are used to frame a packet with frames 1123. In addition, in one example, the receiver also provides a symbol clock recovered from the incoming serial stream.

As stated above, although transaction layer 1105, link layer 1110, and physical layer 1120 are discussed in reference to a specific embodiment of a PCIe protocol stack, a layered protocol stack is not so limited. In fact, any layered protocol may be included/implemented. As an example, a port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 13, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 1306/1311 and a receive pair 1312/1307. Accordingly, device 1305 includes transmission logic 1306 to transmit data to device 1310 and receiving logic 1307 to receive data from device 1310. In other words, two transmitting paths, i.e. paths 1316 and 1317, and two receiving paths, i.e. paths 1318 and 1319, are included in a PCIe link.

A transmission path refers to any path for transmitting data, such as a transmission line, a copper line, an optical line, a wireless communication channel, an infrared communication link, or other communication path. A connection between two devices, such as device 1305 and device 1310, is referred to as a link, such as link 415. A link may support one lane—each lane representing a set of differential signal pairs (one pair for transmission, one pair for reception). To scale bandwidth, a link may aggregate multiple lanes denoted by ×N, where N is any supported Link width, such as 1, 2, 4, 8, 12, 16, 32, 64, or wider.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

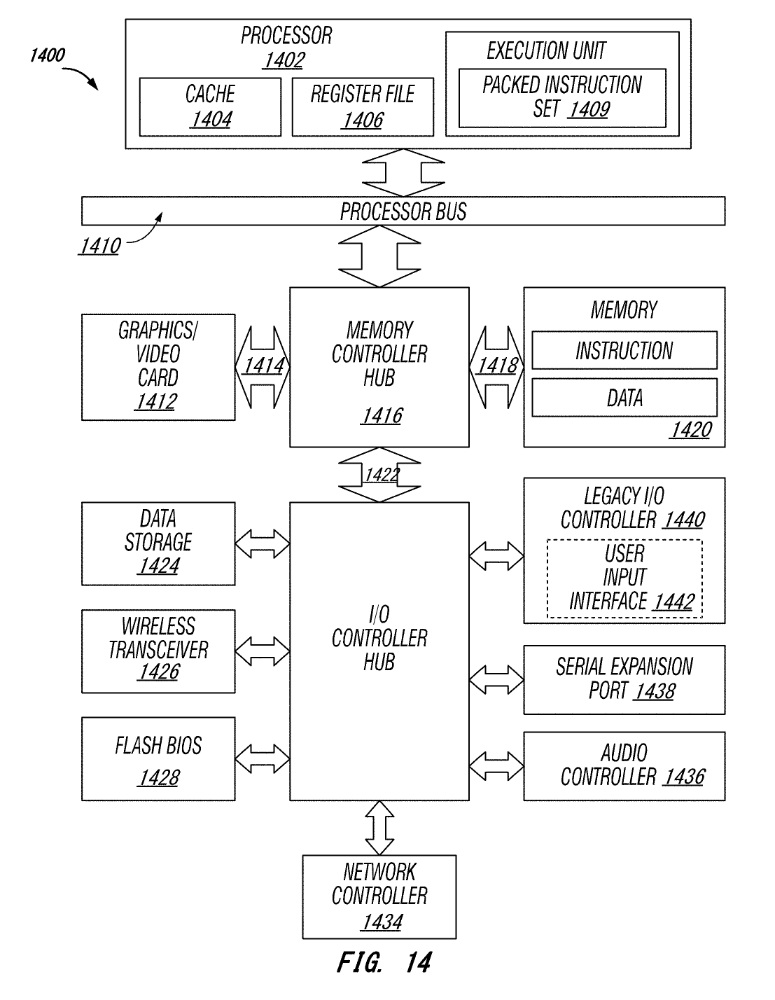

Turning to FIG. 14, a block diagram of an exemplary computer system formed with a processor that includes execution units to execute an instruction, where one or more of the interconnects implement one or more features in accordance with one embodiment of the present invention is illustrated. System 1400 includes a component, such as a processor 1402 to employ execution units including logic to perform algorithms for process data, in accordance with the present invention, such as in the embodiment described herein. System 1400 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 1400 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 1402 includes one or more execution units 1408 to implement an algorithm that is to perform at least one instruction. One embodiment may be described in the context of a single processor desktop or server system, but alternative embodiments may be included in a multiprocessor system. System 1400 is an example of a ‘hub’ system architecture. The computer system 1400 includes a processor 1402 to process data signals. The processor 1402, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 1402 is coupled to a processor bus 1410 that transmits data signals between the processor 1402 and other components in the system 1400. The elements of system 1400 (e.g. graphics accelerator 1412, memory controller hub 1416, memory 1420, I/O controller hub 1424, wireless transceiver 1426, Flash BIOS 1428, Network controller 1434, Audio controller 1436, Serial expansion port 1438, I/O controller 1440, etc.) perform their conventional functions that are well known to those familiar with the art.

In one embodiment, the processor 1402 includes a Level 1 (L1) internal cache memory 1404. Depending on the architecture, the processor 1402 may have a single internal cache or multiple levels of internal caches. Other embodiments include a combination of both internal and external caches depending on the particular implementation and needs. Register file 1406 is to store different types of data in various registers including integer registers, floating point registers, vector registers, banked registers, shadow registers, checkpoint registers, status registers, and instruction pointer register.

Execution unit 1408, including logic to perform integer and floating point operations, also resides in the processor 1402. The processor 1402, in one embodiment, includes a microcode (ucode) ROM to store microcode, which when executed, is to perform algorithms for certain macroinstructions or handle complex scenarios. Here, microcode is potentially updateable to handle logic bugs/fixes for processor 1402. For one embodiment, execution unit 1408 includes logic to handle a packed instruction set 1409. By including the packed instruction set 1409 in the instruction set of a general-purpose processor 1402, along with associated circuitry to execute the instructions, the operations used by many multimedia applications may be performed using packed data in a general-purpose processor 1402. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 1408 may also be used in micro controllers, embedded processors, graphics devices, DSPs, and other types of logic circuits. System 1400 includes a memory 1420. Memory 1420 includes a dynamic random access memory (DRAM) device, a static random access memory (SRAM) device, flash memory device, or other memory device. Memory 1420 stores instructions and/or data represented by data signals that are to be executed by the processor 1402.

Note that any of the aforementioned features or aspects of the invention may be utilized on one or more interconnect illustrated in FIG. 14. For example, an on-die interconnect (ODI), which is not shown, for coupling internal units of processor 1402 implements one or more aspects of the invention described above. Or the invention is associated with a processor bus 1410 (e.g. Intel Quick Path Interconnect (QPI) or other known high performance computing interconnect), a high bandwidth memory path 1418 to memory 1420, a point-to-point link to graphics accelerator 1412 (e.g. a Peripheral Component Interconnect express (PCIe) compliant fabric), a controller hub interconnect 1422, an I/O or other interconnect (e.g. USB, PCI, PCIe) for coupling the other illustrated components. Some examples of such components include the audio controller 1436, firmware hub (flash BIOS) 1428, wireless transceiver 1426, data storage 1424, legacy I/O controller 1410 containing user input and keyboard interfaces 1442, a serial expansion port 1438 such as Universal Serial Bus (USB), and a network controller 1434. The data storage device 1424 can comprise a hard disk drive, a floppy disk drive, a CD-ROM device, a flash memory device, or other mass storage device.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Example 1 may include a card edge connector that includes a through-hole pin-field that wherein the signal pins are disposed bent in an alternating in/out pattern, with respect to the centerline of the contacts.

Example 2 may include the connector described in example 1, having ground pins that are disposed along the centerline of the pin-field.

Example 3 may include the connector described in any of example 1-2, with single ground pins arranged along the centerline, and dual adjacent grounds conforming to the in/out pattern.

Example 4 may include the connector described in example 3 with dual adjacent ground contacts electrically joined within the connector.

Example 5 may include the baseboard printed circuit board pin-field that mates with the connector described in examples 1-4.

Example 6 may include the apparatus described in examples 1-5 and/or some other example herein, wherein supporting the PCI Express interface.

Example 7 may include any of the examples 1-6 and/or some other example herein, with the addition of any of the following connector and mating printed circuit board improvements which have been disclosed separately, including adjacent add-in card ground vias, joined add-in ground vias, merged add-in card edge fingers, AC sideband termination, sentry vias, and buried add-in card resonators, and resistive ground termination.

Example 8 may include the connector in examples 1-7 and/or some other example herein, wherein having a segment-by-segment optimized impedance profile, which may include broadening, narrowing, or otherwise contouring the connector contact, including the gull wing terminal, the ankle that leads to the gull wing terminal, the captivated contact length, and the free-moving beam that mates with the add-in card edge finger.

Example 9 may include the card edge connector with a gull-wing surface mount footprint having a segment-by-segment optimized impedance profile, which may include broadening, narrowing, or otherwise contouring the connector contact, including the ankle that leads to the gull wing terminal, the captivated contact length, and the free-moving beam that mates with the add-in card edge finger.

Example 10 may include the connector in example 9 and/or some other example herein, wherein having a segment-by-segment optimized impedance profile, which may include broadening, narrowing, or otherwise contouring the connector contact, including the gull wing terminal, the ankle that leads to the gull wing terminal, the captivated contact length, and the free-moving beam that mates with the add-in card edge finger.

Example 11 may include any of the connectors discussed in examples 1-10 and/or some other example herein with an optimized connector contact preload and add-in card edge finger design to limit the effects of stub resonance by shortening or otherwise contouring the length and width of these conductors.

Example 11.1 may include a pin-field where the pin outs are all aligned on each side of the card, but in the same “order” as before. This is to accommodate the SMT pin connector of example 9.

Example 12 may include any of the connectors discussed in examples 1-10 and/or some other example herein with a baseboard pin-field via that is optimized in size for signal integrity or to ease routing congestion.

Example 13 may include a card edge connector comprising: a plurality of ground pins along an axis of a through-hole pin-field that includes the ground pins and signal pins; and the plurality of signal pins, wherein the plurality of signal pins are disposed in an alternating in/out pattern with respect to the axis.

Example 14 may include the card edge connector of example 13 and/or some other example herein, wherein the axis is a centerline of contacts of the card edge connector.

Example 15 may include the card edge connector of example 13 and/or some other example herein, wherein the plurality of ground pins are single ground pins, and further comprising dual adjacent ground pins disposed in the alternating in/out pattern.

Example 16 may include the card edge connector of example 13 and/or some other example herein wherein the card edge connector is in accordance with a peripheral component interconnect express (PCIe) interface.

Example 17 may include a system comprising: a baseboard printed circuit board (PCB) with a through-hole pin-field; and a card communicatively coupled with the PCB via the through-hole pin-field; wherein the through-hole pin-field includes: a plurality of ground pins along an axis of the through-hole pin-field; and a plurality of signal pins, wherein the plurality of signal pins are disposed in an alternating in/out pattern with respect to the axis.

Example 18 may include the system of example 17 and/or some other example herein, wherein the axis is a centerline of contacts of the card.

Example 19 may include the system of example 17 and/or some other example herein, wherein the plurality of ground pins are single ground pins, and further comprising dual adjacent ground pins disposed in the alternating in/out pattern.

Example 20 may include the system of example 17 and/or some other example herein wherein the card is communicatively coupled with the PCB via the through-hole pin-field in accordance with a peripheral component interconnect express (PCIe) protocol.

Example 21 may include a method, technique, or process to generate a system or apparatus as described in or related to any of examples 1-20, or portions or parts thereof.

Example 22 is an apparatus that includes a printed circuit board (PCB) comprising a ground plane; and a through-hole pin-field. The through-hole pin-field includes a plurality of ground through-holes arranged along a centerline and electrically coupled to the ground plane; a plurality of ground pins, each of the plurality of ground pins coupled to the ground plane through a corresponding ground through-hole; a first signal though-hole arranged on a first side of the centerline; a second signal through-hole arrange on a second side of the centerline, the first side oppose the second side; a first signal pin electrically connected to a first signal trace in the PCB through the first signal through-hole, the first signal pin comprising a bend in a first direction, the bend disposed proximate the first through-hole; and a second signal pin electrically connected to a second signal trace in the PCB through the second signal through-hole, the second signal pin comprising a bend in a second direction, the second direction opposite the first direction, the bend disposed proximate the second through-hole.

Example 23 may include the subject matter of example 22, wherein the first signal pin and the second signal pin are arranged to contact adjacent metal contact fingers on an add-in card.

Example 24 may include the subject matter of any of examples 22-23, wherein the through-hole pin-field can include a first plurality of signal through-holes arranged on a first side of a centerline; a second plurality of signal through-holes arrange on a second side of the centerline, the second side opposite the first side; a first plurality of signal pins, each of the first plurality of signal pins coupled to the printed circuit board through a corresponding one of the plurality of first signal through-holes, each of the first plurality of signal pins comprising a bend proximate to the through-hole pin-field, the bend oriented in a first direction; and a second plurality of signal pins, each of the second plurality of signal pins coupled to the printed circuit board through a corresponding one of the plurality of second signal through-holes, each of the second plurality of signal pins comprising a bend proximate to the through-hole pin-field, the bend oriented in a second direction opposite the first direction relative to the centerline.

Example 25 may include the subject matter of any of examples 22-24, wherein at least two of the plurality of ground through-holes arranged along the centerline are in contact with each other, forming a ground bridge.

Example 26 may include the subject matter of example 25, wherein the plurality of ground through-holes is a first plurality of ground through-holes, and the plurality of ground pins is a first plurality of ground pins. The apparatus further including a first adjacent ground through-hole arranged on the first side of the centerline and a second adjacent ground through-hole arranged on the second side of the centerline; a first adjacent ground pin coupled to the ground plane through the first adjacent ground through hole, the first adjacent ground pin comprising a bend proximate the through hole pin-field, the bend oriented in the first direction; and a second adjacent ground pin coupled to the ground plane through the second adjacent ground through-hole, the first adjacent ground pin adjacent to the second adjacent ground pin, the second adjacent ground pin comprising a bend proximate the through hole pin-field, the bend oriented in the second direction.

Example 27 may include the subject matter of any of examples 22-26, wherein the first signal pin comprises a bend oriented in an opposite direction relative to the centerline as adjacent signal pin.

Example 28 may include the subject matter of any of examples 22-27, wherein the apparatus is compliant with a peripheral component interconnect express (PCIe) communications protocol.

Example 29 may include the subject matter of any of examples 22-28, and can also include a peripheral component interconnect express (PCIe) compliant connector shell, the connector shell configured to receive a PCIe compliant add-in card and to mechanically and electrically couple the add-in card to the printed circuit board.

Example 30 may include the subject matter of any of examples 22-29, wherein each of the ground pins, the first signal pin, and the second signal pin comprises a segment-by-segment optimized impedance profile, the impedance profile comprising a contour profile.

Example 31 may include the subject matter of any of examples 22-30, wherein the pin-field is a first pin-field, the apparatus comprising a second pin-field disposed adjacent to the first pin-field.

Example 32 may include the subject matter of example 31, wherein the second pin-field comprises a plurality of ground pins and signal pins arranged in a same order as the ground pins and signal pins of the first pin-field.

Example 33 may include the subject matter of any of examples 22-32, wherein each of the ground pins, the first signal pin, and the second signal pin comprises a gullwing-shaped contact comprising a preload tension.

Example 34 may include the subject matter of any of examples 22-33, wherein each of the ground through-holes, the first signal through-hole, and the second signal through-hole comprises a diameter optimized for one or more of signal integrity or routing.

Example 35 is a system that includes a baseboard printed circuit board (PCB) with a through-hole pin-field; and an add-in card communicatively coupled with the PCB via the through-hole pin-field. The through-hole pin-field includes a plurality of ground through-holes arranged along a centerline and electrically coupled to the ground plane; a plurality of ground pins, each of the plurality of ground pins coupled to the ground plane through a corresponding ground through-hole; a first signal though-hole arranged on a first side of the centerline; a second signal through-hole arrange on a second side of the centerline, the first side oppose the second side; a first signal pin electrically connected to a first signal trace in the PCB through the first signal through-hole, the first signal pin comprising a bend in a first direction, the bend disposed proximate the first through-hole; and a second signal pin electrically connected to a second signal trace in the PCB through the second signal through-hole, the second signal pin comprising a bend in a second direction, the second direction opposite the first direction, the bend disposed proximate the second through-hole.

Example 36 may include the subject matter of example 35 wherein the first signal pin and the second signal pin are arranged to contact adjacent metal contact fingers on an add-in card.

Example 37 may include the subject matter of any of examples 35-36, wherein the through-hole pin-field also includes a first plurality of signal through-holes arranged on a first side of a centerline; a second plurality of signal through-holes arrange on a second side of the centerline, the second side opposite the first side; a first plurality of signal pins, each of the first plurality of signal pins coupled to the printed circuit board through a corresponding one of the plurality of first signal through-holes, each of the first plurality of signal pins comprising a bend proximate to the through-hole pin-field, the bend oriented in a first direction; and a second plurality of signal pins, each of the second plurality of signal pins coupled to the printed circuit board through a corresponding one of the plurality of second signal through-holes, each of the second plurality of signal pins comprising a bend proximate to the through-hole pin-field, the bend oriented in a second direction opposite the first direction relative to the centerline.

Example 38 may include the subject matter of example 35-37, wherein at least two of the plurality of ground through-holes arranged along the centerline are in contact with each other, forming a ground bridge.

Example 39 may include the subject matter of example 38, wherein the plurality of ground through-holes is a first plurality of ground through-holes, and the plurality of ground pins is a first plurality of ground pins; the apparatus also including a first adjacent ground through-hole arranged on the first side of the centerline and a second adjacent ground through-hole arranged on the second side of the centerline; a first adjacent ground pin coupled to the ground plane through the first adjacent ground through hole, the first adjacent ground pin comprising a bend proximate the through hole pin-field, the bend oriented in the first direction; and a second adjacent ground pin coupled to the ground plane through the second adjacent ground through-hole, the first adjacent ground pin adjacent to the second adjacent ground pin, the second adjacent ground pin comprising a bend proximate the through hole pin-field, the bend oriented in the second direction.

Example 40 may include the subject matter of any of examples 35-39, wherein the first signal pin comprises a bend oriented in an opposite direction relative to the centerline as adjacent signal pin.

Example 41 may include the subject matter of any of examples 35-40, and can also include a peripheral component interconnect express (PCIe) compliant connector shell, the connector shell configured to receive a PCIe compliant add-in card and to mechanically and electrically couple the add-in card to the printed circuit board.

Example 42 is an apparatus that includes a Peripheral Component Interconnect Express (PCIe) compliant connector, the PCIe connector including a through-hole pin-field comprising: a plurality of ground pins along an axis of the through-hole pin-field; and a plurality of signal pins, wherein the plurality of signal pins are disposed in an alternating in/out pattern with respect to the axis.

Example 43 may include the subject matter of example 42, wherein the axis is a centerline of contacts of the add-in card.

Example 44 may include the subject matter of any of examples 42-43, wherein the plurality of ground pins comprise single ground pins, and further comprises dual adjacent ground pins disposed in the alternating in/out pattern.

Example 45 may include the subject matter of any of examples 43-44, wherein the add-in card is communicatively coupled with the PCB by the through-hole pin-field based on a peripheral component interconnect express (PCIe) protocol.

Example 46 may include the subject matter of any of examples 42-45, and can also include a connector cover covering each of the ground pins and signal pins, the connector cover exposing the ground pins and signal pins to contact the add-in card.

Example 47 may include the subject matter of example 22-26, wherein at least two of the plurality of ground pins are in contact with each other, the at least two of the plurality of ground pins in contact with each other forming a ground bridge.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. An apparatus comprising:
a printed circuit board (PCB) comprising a ground plane; and
a through-hole pin-field comprising:
a plurality of ground through-holes arranged along a centerline and electrically coupled to the ground plane;
a plurality of ground pins, each of the plurality of ground pins coupled to the ground plane through a corresponding ground through-hole; and
a first signal though-hole arranged on a first side of the centerline;
a second signal through-hole arrange on a second side of the centerline, the first side oppose the second side;
a first signal pin electrically connected to a first signal trace in the PCB through the first signal through-hole, the first signal pin comprising a bend in a first direction, the bend disposed proximate the first through-hole; and
a second signal pin electrically connected to a second signal trace in the PCB through the second signal through-hole, the second signal pin comprising a bend in a second direction, the second direction opposite the first direction, the bend disposed proximate the second through-hole.

2. The apparatus of claim 1, wherein the first signal pin and the second signal pin are arranged to contact adjacent metal contact fingers on an add-in card.

3. The apparatus of claim 1, wherein the through-hole pin-field comprising:
a first plurality of signal through-holes arranged on a first side of a centerline;
a second plurality of signal through-holes arrange on a second side of the centerline, the second side opposite the first side;
a first plurality of signal pins, each of the first plurality of signal pins coupled to the printed circuit board through a corresponding one of the plurality of first signal through-holes, each of the first plurality of signal pins comprising a bend proximate to the through-hole pin-field, the bend oriented in a first direction; and
a second plurality of signal pins, each of the second plurality of signal pins coupled to the printed circuit board through a corresponding one of the plurality of second signal through-holes, each of the second plurality of signal pins comprising a bend proximate to the through-hole pin-field, the bend oriented in a second direction opposite the first direction relative to the centerline.

4. The apparatus of claim 1, wherein at least two of the plurality of ground pins arranged along the centerline are in contact with each other, forming a ground bridge.

5. The apparatus of claim 4, wherein the plurality of ground through-holes is a first plurality of ground through-holes, and the plurality of ground pins is a first plurality of ground pins; the apparatus further comprising:
a first adjacent ground through-hole arranged on the first side of the centerline and a second adjacent ground through-hole arranged on the second side of the centerline;
a first adjacent ground pin coupled to the ground plane through the first adjacent ground through hole, the first adjacent ground pin comprising a bend proximate the through hole pin-field, the bend oriented in the first direction;
a second adjacent ground pin coupled to the ground plane through the second adjacent ground through-hole, the first adjacent ground pin adjacent to the second adjacent ground pin, the second adjacent ground pin comprising a bend proximate the through hole pin-field, the bend oriented in the second direction.

6. The apparatus of claim 5, wherein at least two of the plurality of ground pins are in contact with each other, the at least two of the plurality of ground pins in contact with each other forming a ground bridge.

7. The apparatus of claim 1, wherein the first signal pin and the second signal pin are adjacent signal pins, and one of the first signal pin or the second signal pin is adjacent to a ground pin.

8. The apparatus of claim 1, further comprising a peripheral component interconnect express (PCIe) compliant connector shell, the connector shell configured to receive a PCIe compliant add-in card and to mechanically and electrically couple the add-in card to the printed circuit board.

9. The apparatus of claim 1, wherein each of the ground pins, the first signal pin, and the second signal pin comprises a segment-by-segment optimized impedance profile, the impedance profile comprising a contour profile.

10. The apparatus of claim 1, wherein the pin-field is a first pin-field, the apparatus comprising a second pin-field disposed adjacent to the first pin-field.

11. The apparatus of claim 10, wherein the second pin-field comprises a plurality of ground pins and signal pins arranged in a same order as the ground pins and signal pins of the first pin-field.

12. The apparatus of claim 1, wherein each of the ground pins, the first signal pin, and the second signal pin comprises a gullwing-shaped contact comprising a preload tension.

13. The apparatus of claim 1, wherein each of the ground through-holes, the first signal through-hole, and the second signal through-hole comprises a diameter optimized for one or more of signal integrity or routing.

14. A system comprising:
a baseboard printed circuit board (PCB) with a through-hole pin-field; and
an add-in card communicatively coupled with the PCB via the through-hole pin-field;
the through-hole pin-field comprising:
a plurality of ground through-holes arranged along a centerline and electrically coupled to the ground plane;
a plurality of ground pins, each of the plurality of ground pins coupled to the ground plane through a corresponding ground through-hole;
a first signal though-hole arranged on a first side of the centerline;
a second signal through-hole arrange on a second side of the centerline, the first side oppose the second side;
a first signal pin electrically connected to a first signal trace in the PCB through the first signal through-hole, the first signal pin comprising a bend in a first direction, the bend disposed proximate the first through-hole; and
a second signal pin electrically connected to a second signal trace in the PCB through the second signal through-hole, the second signal pin comprising a bend in a second direction, the second direction opposite the first direction, the bend disposed proximate the second through-hole.

15. The system of claim 14, wherein the first signal pin and the second signal pin are arranged to contact adjacent metal contact fingers on an add-in card.

16. The system of claim 14, wherein the through-hole pin-field comprising:
a first plurality of signal through-holes arranged on a first side of a centerline;
a second plurality of signal through-holes arrange on a second side of the centerline, the second side opposite the first side;
a first plurality of signal pins, each of the first plurality of signal pins coupled to the printed circuit board through a corresponding one of the plurality of first signal through-holes, each of the first plurality of signal pins comprising a bend proximate to the through-hole pin-field, the bend oriented in a first direction; and
a second plurality of signal pins, each of the second plurality of signal pins coupled to the printed circuit board through a corresponding one of the plurality of second signal through-holes, each of the second plurality of signal pins comprising a bend proximate to the through-hole pin-field, the bend oriented in a second direction opposite the first direction relative to the centerline.

17. The system of claim 14, wherein at least two of the plurality of ground pins are arranged along the centerline are in contact with each other, forming a ground bridge.

18. The system of claim 17, wherein the plurality of ground through-holes is a first plurality of ground through-holes, and the plurality of ground pins is a first plurality of ground pins; the apparatus further comprising:
a first adjacent ground through-hole arranged on the first side of the centerline and a second adjacent ground through-hole arranged on the second side of the centerline;
a first adjacent ground pin coupled to the ground plane through the first adjacent ground through hole, the first adjacent ground pin comprising a bend proximate the through hole pin-field, the bend oriented in the first direction; and
a second adjacent ground pin coupled to the ground plane through the second adjacent ground through-hole, the first adjacent ground pin adjacent to the second adjacent ground pin, the second adjacent ground pin comprising a bend proximate the through hole pin-field, the bend oriented in the second direction.

19. The system of claim 14, wherein the first signal pin comprises a bend oriented in an opposite direction relative to the centerline as an adjacent signal pin.

20. The system of claim 14, further comprising a peripheral component interconnect express (PCIe) compliant connector shell, the connector shell configured to receive a PCIe compliant add-in card and to mechanically and electrically couple the add-in card to the printed circuit board.

21. An apparatus comprising:
a Peripheral Component Interconnect Express (PCIe) compliant connector, the PCIe connector comprising:
a through-hole pin-field comprising: a plurality of ground pins along an axis of the through-hole pin-field; and a plurality of signal pins, wherein the plurality of signal pins are disposed in an alternating in/out pattern with respect to the axis.

22. The apparatus of claim 21, wherein the axis is a centerline of contacts of the add-in card.

23. The apparatus of claim 21, wherein the plurality of ground pins comprise single ground pins, and further comprises dual adjacent ground pins disposed in the alternating in/out pattern.

24. The apparatus of claim 21, wherein the add-in card is communicatively coupled with the PCB by the through-hole pin-field based on a peripheral component interconnect express (PCIe) protocol.

25. The apparatus of claim 21, further comprising a connector cover covering each of the ground pins and signal pins, the connector cover exposing the ground pins and signal pins to contact the add-in card.
